(19) United States
(12) Patent Application Publication
(10) Pub. No.: US 2015/0095163 A1
(43) Pub. Date: Apr. 2, 2015

(54) Electronic Apparatus and Display Method

(71) Applicant: Kabushiki Kaisha Toshiba, Tokyo (JP)

(72) Inventors: Takashi Sudo, Fuchu-shi (JP); Yasuhiro Kanishima, Tokyo (JP); Shingo Suzuki, Sagamihara-shi (JP); Takaya Matsuno, Kunitachi-shi (JP); Akira Tanaka, Mitaka-shi (JP); Shuichi Sekine, Hachioji-shi (JP)

(73) Assignee: Kabushiki Kaisha Toshiba, Tokyo (JP)

(21) Appl. No.: 14/289,417

(22) Filed: May 28, 2014

(30) Foreign Application Priority Data
Sep. 30, 2013 (JP) 2013-203420

(51) Int. Cl. G06Q 30/02

(52) U.S. Cl. CPC G06Q 30/0269
USPC 705/14.66

(57) ABSTRACT

According to one embodiment, an electronic apparatus includes a processor and a display processor. The processor acquires a target value about health of a user and acquires behavioral information related to the target value from a recorder configured to record a behavior of the user and to acquire physiological information of the user. The display processor displays a first screen includes a performance value according to the behavioral information, the target value, and an advertisement selected according to the physiological information on a display.

### CROSS-REFERENCE TO RELATED APPLICATIONS

This application is based upon and claims the benefit of priority from Japanese Patent Application No. 2013-203420, filed Sep. 30, 2013, the entire contents of which are incorporated herein by reference.

### FIELD

Embodiments described herein relate generally to an electronic apparatus and display means thereof.

### BACKGROUND

In a healthcare system for older people, health is managed by training, physiological information sensing, and the like.

Regarding healthcare for older people, it is important to provide a system to create a purpose in life so that such people can live in a positive (mental), healthy (physical) and pleasant (hobby) way.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary diagram showing a structure of a healthcare system of an embodiment.

FIG. 2 is an exemplary diagram of a healthcare channel screen.

FIG. 3 is an exemplary flowchart showing a procedure that displays the healthcare channel screen.

FIG. 4 is an exemplary diagram showing a function added to a television apparatus.

FIG. 5 is an exemplary diagram showing a function added to the television apparatus.

FIG. 6 is an exemplary diagram showing a function added to the television apparatus.

### DETAILED DESCRIPTION

Various embodiments will be described hereinafter with reference to the accompanying drawings.

In general, according to one embodiment, a processor and a display processor. The processor acquires a target value about health of a user and acquires behavioral information related to the target value from a recorder configured to record a behavior of the user and to acquire physiological information of the user. The display processor displays a first screen comprising a performance value according to the behavioral information, the target value, and an advertisement selected according to the physiological information on a display.

According to one embodiment, an electronic apparatus includes an acquisition module and a display processing module. The acquisition module is configured to acquire target information which shows a target value about health of a user and to acquire information corresponding to the target information from a recorder which records behavioral information about a behavior of the user. The display processing module is configured to display a first screen on a display. The first screen comprises performance information which shows a performance value to the target value based on the behavioral information and the target information.

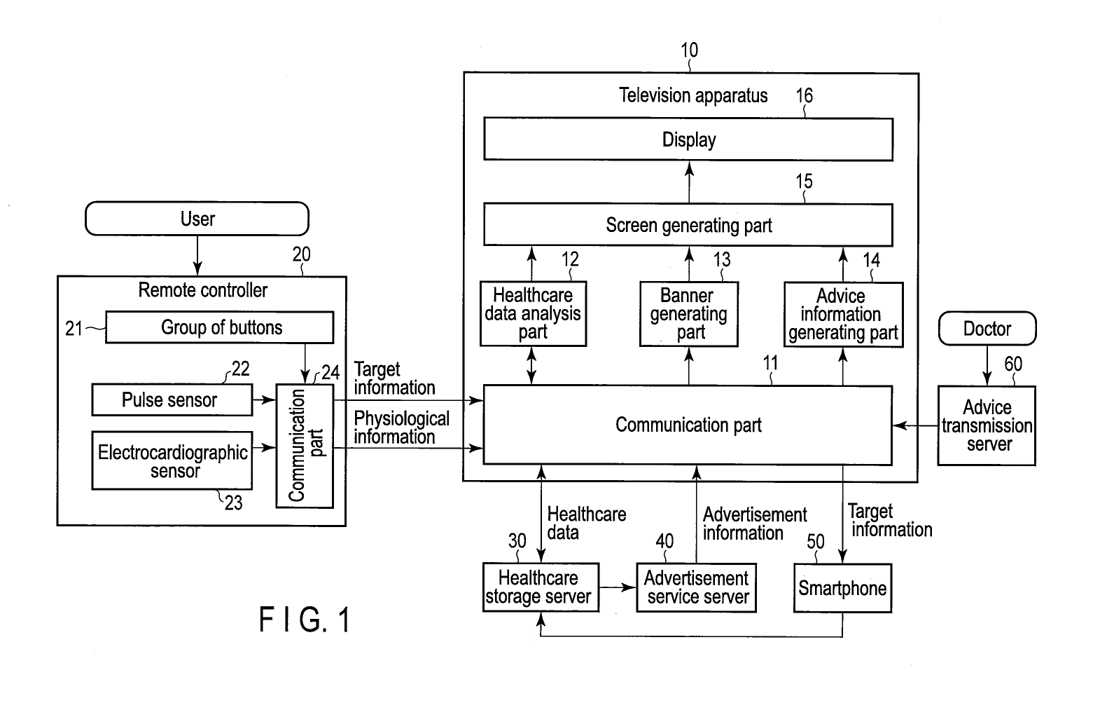

FIG. 1 is an exemplary diagram illustrating a structure of a healthcare system.

The healthcare system comprises a television apparatus 10 as an electronic apparatus, a remote controller 20, a healthcare data storage server 30, an advertisement service server 40, a smartphone 50, an advice transmission server 60, and the like.

The smartphone 50 as a recorder records behavioral information about a user's behavior. The smartphone 50 has a pedometer function to count the number of steps walked, a diet recording management function to record and manage diet, and an exercise recording management function to record and manage the user's exercise. Also, the smartphone 50 has a function to notify the television apparatus 10 of behavioral information such as the number of steps walked, diet and user's exercise. Behavioral information may be notified automatically or manually.

The television apparatus 10 comprises a communication part 11, a healthcare data analysis part 12, a banner generating part 13, an advice information generating part 14, a screen generating part 15, a display 16, and the like.

The remote controller 20 comprises a group of buttons 21, a pulse sensor 22, an electrocardiographic sensor 23, a communication part 24, and the like. The group of buttons 21 comprises a power button to power on the television apparatus 10, a number button to select a channel, and the like. The pulse sensor 22 measures the pulse of a user when he holds the remote controller 20. The electrocardiographic sensor 23 measures the electrocardiogram of a user when he holds the remote controller 20.

A power-on signal to power on the television apparatus 10 is transmitted from the remote controller 20 by operating the power button in the group of buttons, and when the television apparatus 10 is powered on for the first time in a day, the pulse sensor 22 and the electrocardiographic sensor 23 of the remote controller 20 held by a user sense physiological information such as the pulse and electrocardiogram. After sensing, the physiological information is transmitted to the television apparatus 10 by the communication part 24.

A user uses the group of buttons 21 of the remote controller 20 to input an exercise target, a calorie intake target, a calorie consumption target, and the like. The target information input is transmitted to the television apparatus 10 via the communication part 24.

The healthcare data analysis part 12 analyzes degree of stress, cartilage age, blood pressure and the like from physiological information transmitted from the remote controller 20 and information from healthcare management equipment (for example, weight from a weighing machine, blood pressure from a manometer).

The above-mentioned pulse interval data showing fluctuation of pulse interval is generated by analyzing an input time-series signal of the pulse sensor 22. The healthcare data analysis part 12 measures degree of stress based on the power spectrum in a low-frequency region (LF) and the power spectrum in a high-frequency region (HF) acquired respectively by converting the pulse interval data within a predetermined period into a frequency spectrum distribution. In this case, the LF/HF represents degree of stress.

The healthcare data analysis part 12 calculates a performance value for each target based on the number of steps walked, diet and user's exercise notified from the smartphone 50 and an exercise target, a calorie intake target and a calorie consumption target.

The television apparatus 10 displays a healthcare channel. A healthcare channel button to display the healthcare channel may be provided on a remote controller so that the healthcare channel can be viewed later. The healthcare channel displays physiological information acquired everyday and information, from health management equipment connected on other networks (for example, weight from a weighing machine). Also, information analyzed from the physiological information (for example, degree of stress, cartilage age and blood pressure) may be displayed. A user confirms anti-aging information and advice given by a doctor from a performance value to a yesterday's target value. The physiological information transmitted from the remote controller 20 and the like and the healthcare date including a performance value are stored in the healthcare data storage server 30.

The advertisement service server 40 selects advertisement information effective for a user by analyzing a part of the data stored in the healthcare data storage server 30. For example, the advertisement service server 40 selects an advertisement of food that can reduce stress, if a user has severe stress. The advertisement service server 40 transmits the selected advertisement information to the television apparatus 10. The television apparatus 10 can store plural pieces of advertisement information (video advertisement data and banner advertisement data). Video advertisement data includes thumbnail image data, URL data and video data. Banner advertisement data includes image data and URL data.

A doctor gives advice to a user in reference to the healthcare data stored in the healthcare data storage server 30. The advice is transmitted from the advice transmission server 60 to the television apparatus 10. The advice information generating part 14 generates advice information based on the advice transmitted from the advice transmission server 60.

The screen generating part 15 generates the healthcare channel screen based on the analysis result by the healthcare data analysis part 12, the advertisement information selected from the banner generating part 13, and the advice information generated from the advice information generating part 14.

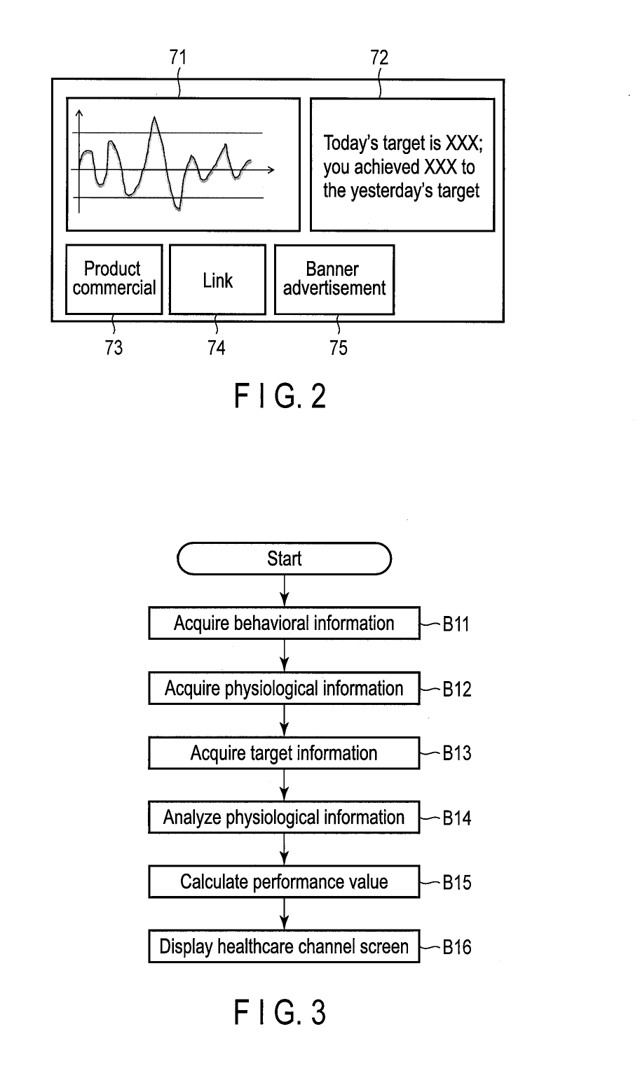

FIG. 2 is an exemplary diagram of the healthcare channel screen.

As shown in FIG. 2, the healthcare channel screen shows a time-series graph 71 about data history such as weight, cartilage age and stress based on the physiological information transmitted from the remote controller 20, the behavioral information transmitted from the smartphone 50, and the healthcare data stored in the healthcare data storage server 30. The healthcare channel screen displays a message display 72. The message display 72 displays a today's target input from the remote controller 20, a performance value to a yesterday's target, the advice transmitted from the advertisement transmission server 60, and the like.

The healthcare channel screen shows a product commercial button 73, a link button 74 and a banner advertisement button 75. When the product commercial button 73 is pressed, the screen generating part 15 reproduces and displays video data included in a piece of video advertisement data transmitted from the advertisement service 40 by a L-shaped screen. When the link button 74 is pressed, a website is displayed based on the URL data included in video advertisement data corresponding to the reproduced and displayed video data. This website is, for example, a website on which a user can purchase a product introduced in video data. When the banner advertisement button 75 is pressed, a website corresponding to a banner advertisement is displayed on the display 16.

FIG. 3 is an exemplary flowchart illustrating a procedure that displays the healthcare channel screen.

When a date changes, the communication part 11 acquires behavioral information from the smartphone 50 (block B11). By pressing the power-on button in the group of buttons 21, a power-on signal to power on the television apparatus 10 is transmitted from the remote controller 20, and if the television apparatus 10 is powered on for the first time in a day, the communication part 11 acquires physiological information from the remote controller 20 and the like (block B12). This acquisition may be made every time a user holds the remote controller 20. The communication part 11 acquires target information based on the physiological information (block B13). The healthcare data analysis part 12 analyzes physiological information based thereon (block B14). The healthcare data analysis part 12 calculates an effective value based on the target information acquired yesterday and the yesterday's behavioral information (block B15). The screen generating part 15 displays information showing the analysis result of physiological information and the healthcare channel screen including an effective value and the like.

It is possible to create purpose in life to a user by displaying a performance value to a target set by a user, based on the behavioral information notified from the smartphone 50.

### First Additional Function

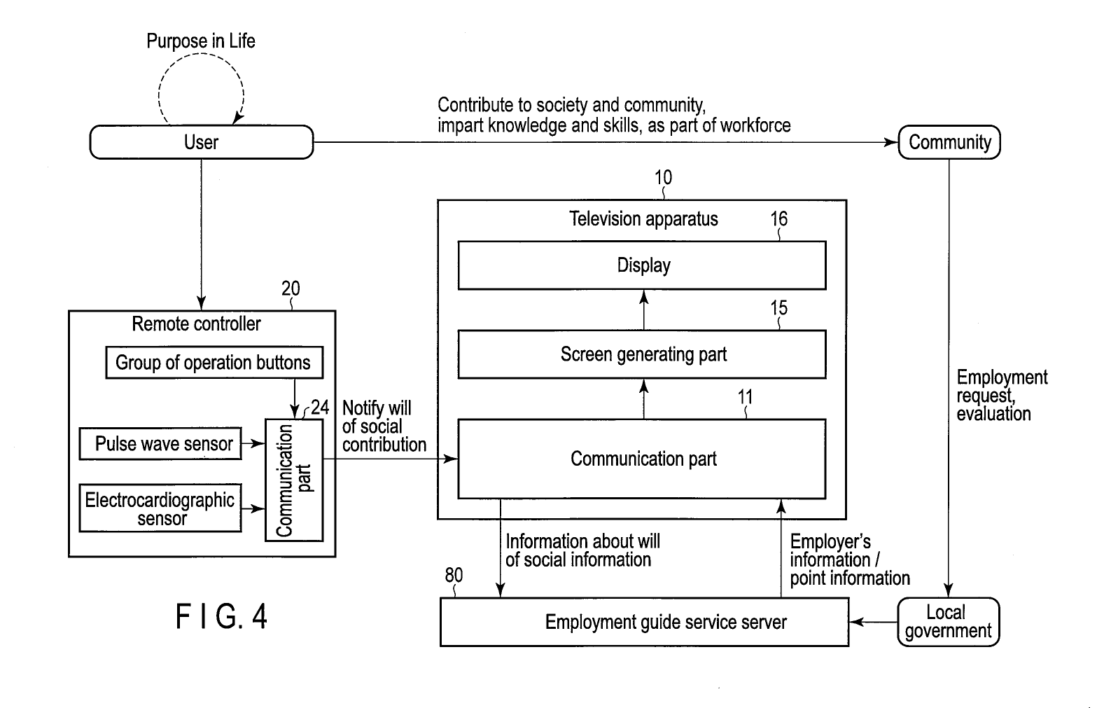

FIG. 4 is an exemplary diagram illustrating a function added to a television apparatus.

The television apparatus 10 communicates with an employment guide service server 80. A community (employer) requests a local government to gather people (employment request). Upon request, the local government registers employer's information such as employment content and employer's address.

When the communication part 11 receives a notice of will of social contribution by pressing the groups of buttons 21 of the remote controller 20, the communication part 11 notifies the employment guide service server 80 of information about will of social contribution. The employment guide service server 80 transmits employer's information registered by a local government to the television apparatus 10. The screen generating part 15 displays on the display 16 a screen that shows employment content and employer's address based on the employer's information.

A user contributes to society and the community, and imparts knowledge, skills, and the like at his workplace. The employer evaluates how he contributes while the local government registers information about the contribution evaluation in the employment guide service server 80. The employment guide service server 80 notifies the television apparatus 10 of point information according to the contribution evaluation information.

The screen generating part 15 displays a code number included in the notified point information. A user can acquire regional promotion tickets by showing the code number.

This additional function develops a cloud service on internet about employment guide and recruitment of helper in a community of local work, in collaboration with a local government. A user uses the television apparatus 10 to apply for these local works and volunteer. The local government offers recruitment to get volunteers securely. In a workplace of an organization that offers local work, a user is evaluated, a point according to how a user contributes is given, and regional promotion tickets that can be used in a local community are distributed. A user improves his quality in life by contributing to the community and imparting skills as well as gets joy of being evaluated and financial rewards of regional promotion tickets and points. Therefore, it is possible to create win-win relationships between a user, a local community and an organization that needs work force.

### Second Additional Function

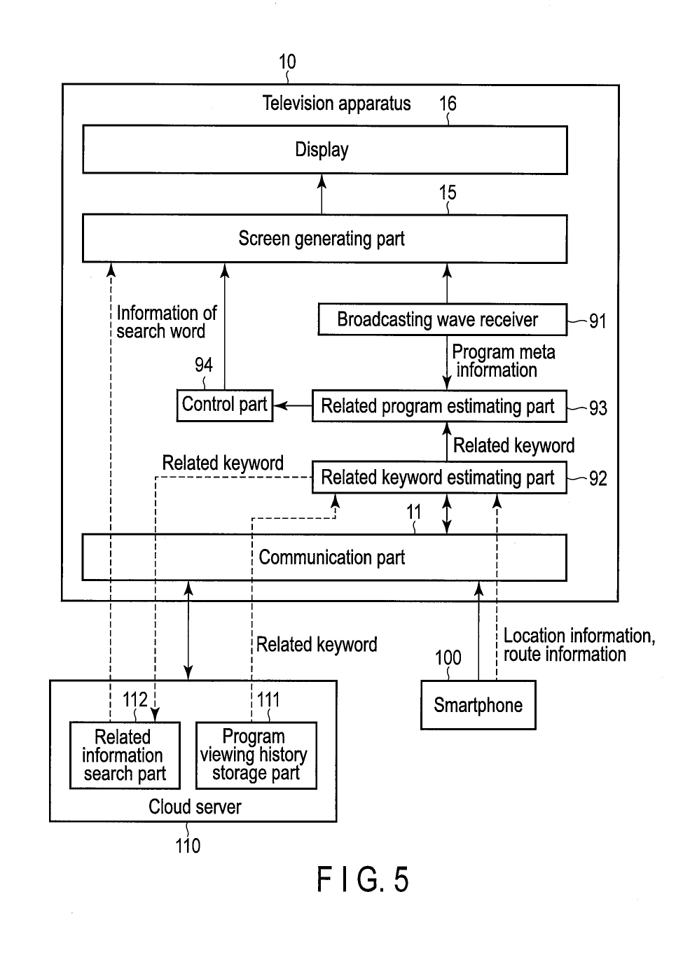

FIG. 5 is an exemplary diagram illustrating a function added to the television apparatus. The television apparatus 10 comprises a broadcasting wave receiver 91, a related keyword estimating part 92, a related program estimating part 93, a control part 94, and the like.

The communication part 11 communicates with a smartphone 100, a cloud server 110, and the like. The smartphone 100 belongs to a family who lives together or a family who does not live together. The smartphone 100 comprises a GPS system to notify the television apparatus 10 of location information and route information.

The cloud server 110 comprises a program viewing history storage part 111, a related information search part 112, and the like. The program viewing history storage part 111 stores meta information of a program viewed in the past. The related information search part 112 acquires, from a search website connected to internet or the like, information related to a related keyword estimated by the related keyword estimating part 92, which will be described later. The searched information is notified to the screen generating part 15. The screen generating part 15 displays the searched information on the display 16.

The broadcasting wave receiver 91 receives a broadcasting wave transmitted from a broadcast station. The related keyword estimating part 92 estimates a related keyword based on either of location information and route information transmitted from the smartphone 100 or meta information stored in the program viewing history storage part 111. The related program estimating part 93 estimates a program related to related keyword from an on-air program, based on meta information of an on-air program and a related keyword estimated by the related keyword estimating part 92. The control part 94 generates information of a related program estimated by the related program estimating part 93. The screen generating part 15 displays information of a related program on the display 16.

It is possible to have a nice chat by estimating a related program from location information moved during travel and showing it to a family who lives together or a family who does not live together.

Also, it is possible to estimate and show a place where a user might want to visit (travel agency), a recommended product, a restaurant and a hobby (tennis court, soccer ticket) from a history of programs viewed in the past.

### Third Additional Function

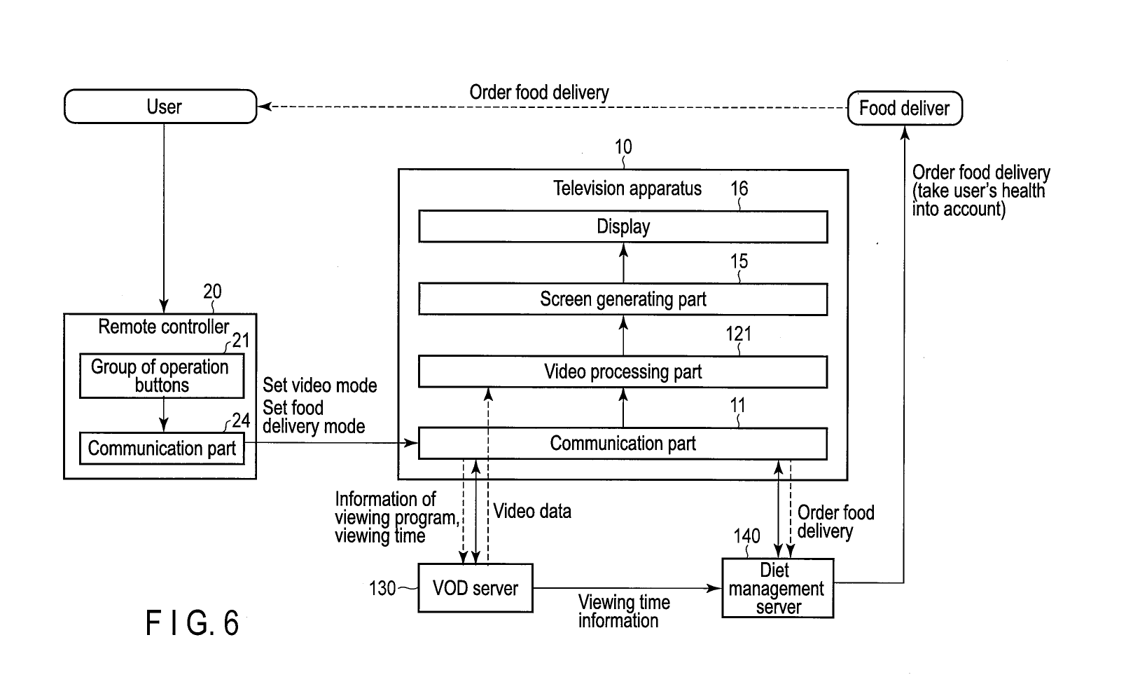

FIG. 6 is an exemplary diagram illustrating a function added to the television apparatus. The television apparatus 10 further comprises a video processing part 121.

When a food delivery mode is set by operating the group of buttons 21 of the remote controller 20, the communication part 11 orders food delivery to a diet management server 140. Also, when a video mode is set by operating the group of buttons 21 of the remote controller 20, the communication part 11 notifies a VOD server 130 of a viewing time and a viewing program. The VOD server 130 notifies the diet management server 140 of viewing time information showing a viewing time. The diet management server 140 orders to a deliverer delivery of food, in which user's health is taken into account. A deliverer delivers food to a user at a time based on viewing time information (for example, right before a viewing time).

The VOD server 130 distributes video data to the television apparatus 10 at a viewing time. The video processing part 121 makes the distributed video data sepia. The video processing part 121 displays the sepia video on the display 16.

It is possible to manage diet while enjoying hobby by showing a user a video during meal. It is also possible for a user to remember the past by viewing sepia video.

Also, since each processing in the present embodiment can be realized by a computer program, the same effect as the present embodiment can be easily realized only by installing and executing the computer program to a normal computer through a computer-readable storage medium that stores the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus, comprising:
a processor configured to acquire a target value about health of a user and to acquire behavioral information related to the target value from a recorder configured to record a behavior of the user and to acquire physiological information of the user; and
a display processor configured to display a first screen comprising a performance value according to the behavioral information, the target value, and an advertisement selected according to the physiological information on a display.

2. The apparatus of claim 1, wherein
the processor is configured to acquire a power-on signal to power on the apparatus from a remote controller; and
the display processor is configured to display the first screen on the display if the power-on signal is acquired.

3. The apparatus of claim 2, wherein
the display processor is configured to display the first screen on the display if the power-on signal is transmitted from the controller for a first time in a day.

4. The apparatus of claim 2, wherein
the acquisition module is configured to acquire physiological information of the user from the controller; and
the display processor is configured to display on the display the first screen further comprising an advertisement based on advertisement data selected based on the physiological information and transmitted from a first server.

5. The apparatus of claim 2, wherein the acquisition module is configured to acquire physiological information of the user from the controller; and
the display processor is configured to display, on the display, the first screen further comprising a piece of advice based on advice data made based on the physiological information and transmitted from a second server.

6. The apparatus of claim 2, wherein
the display processor is configured to display, on the display, a second screen which shows an employer based on employment information transmitted from a third server if first information is transmitted from the controller.

7. The apparatus of claim 1, further comprising an estimate module is configured to estimate, based on location information transmitted from a mobile device, a related program related to the location information from an on-air program, wherein
the display processor is configured to display the related program on the display.

8. A display method comprising:
acquiring a target value about health of a user;
acquiring behavioral information related to the target value from a recorder configured to record a behavior of the user and to acquire physiological information of the user; and
displaying a first screen comprising a performance value according to the behavioral information, the target value, and an advertisement selected according to the physiological information on a display.
